(19) United States
(12) Patent Application Publication
(10) Pub. No.: US 2004/0020023 A1
(43) Pub. Date: Feb. 5, 2004

(54) Clip driver

(76) Inventor: Kuo-Jen Hsu, Tainan Hsien (TW)

Correspondence Address: Kuo-Jen Hsu, P.O. Box 90, Tainan City, 704, TW

(21) Appl. No.: 10/208,785

(22) Filed: Aug. 1, 2002

(51) Int. Cl. B23P 11/00

(52) U.S. Cl. 29/243.56

(57) ABSTRACT

A clip driver in the present invention includes a base having a channel, a feed inlet, an elongated slot and an engagement hole; a follow member being combined in the channel and having a projection hooked by a first spring whose the other end hooking the engagement hole; an upper cap being pivoted on the base and having an elongated through groove and a hook block; and, an operation member being combined in the elongated through groove and connected with the upper cap by a second spring. Clips are filled into the channel from the feed inlet and urged by the follow member to advance close to each other. Only push the operation member forwards with fingers to push a foremost clip out to clip sheets of paper, whereby the clips can be displaced quickly and steadily to clip sheets of paper one by one in continuous operations.

### BACKGROUND OF THE INVENTION

1. Field of the Invention

This invention relates to a clip driver, particularly to one including a base, a follow member, an upper cap and an operation member, wherein the base has a channel and a feed inlet disposed therein; the follow member combined in the channel of the base for urging clips is connected with the base by a first spring; the upper cap pivoted on the base has an elongated through groove and a hook block; and, the operation member combined in the elongated through groove of the upper cap for pushing the clips forwards is connected with the upper cap by a second spring. The clips can be filled into the channel from the feed inlet one by one and urged by the follow member to advance close to each other. After the upper cap is closed, only push the operation member forwards with fingers to push a foremost clip out to clip sheets of paper or documents, by which the clips can be displaced quickly and steadily to clip sheets of paper or documents one by one in continuous operations.

2. Description of the Prior Art

Generally speaking, people often use staplers or paper clips to bind or clip sheets of paper or documents together. However, the conventional way of using staplers to bind the sheets of paper or documents is likely to make the sheets of paper or documents damaged, or even ruined; the conventional way of using paper clips to clip the sheets of paper or documents often makes the sheets of paper or documents become loosened, or even lost. Therefore, elastic clips are used to clip more sheets of paper or documents because its good clipping force can clip more sheets of paper or documents tightly without worrying of being loosened or lost so that the clip driver of the present invention is improved to make the clipping work more easy, smooth and convenient.

### SUMMARY OF THE INVENTION

The main purpose of the invention is to offer a clip driver capable of filling clips promptly and displacing the clips quickly and steadily to make the work of clipping sheets of paper or documents more easy, smooth and convenient.

The main feature of the invention is to provide a base having two supporting edges respectively disposed at both sides thereof, at least one engagement block disposed on an outer surface of each of two sidewalls thereof, a feed inlet disposed at a proper position thereof, a channel disposed therein, and a clipping opening formed in a front end thereof, the channel having two slide grooves respectively disposed at both sides thereof and an elongated slot disposed at a bottom thereof;

a follow member being combined in the channel of the base for urging clips to advance close to each other, and having a projection downwardly protruded from a bottom surface thereof and capable of extending into the elongated slot of the channel to be hooked by one end of a first spring whose the other end hooking in front of the elongated slot of the channel;

an upper cap being pivoted on the base, and having an elongated through groove formed thereon, at least one engagement groove disposed in an inner surface of each of two sidewalls thereof for corresponding in location to the engagement blocks of the base, and a hook block disposed in a proper position of an inner surface thereof; and,

an operation member being combined in the elongated through groove of the upper cap, and having a push end extending from a front end thereof and a hook block disposed at a bottom thereof and capable of being connected with the hook block of the upper cap by a second spring.

### BRIEF DESCRIPTION OF DRAWINGS

This invention will be better understood by referring to the accompanying drawings, wherein:

FIG. 1 is a perspective view of a clip driver in the present invention being in an open status;

FIG. 2 is a perspective view of the clip driver in the present invention being in a close status;

FIG. 3 is a sectional view of the clip driver in the present invention, showing clips being filled in a channel of a base;

FIG. 4 is a schematic sectional view of the clip driver in the present invention, showing a foremost clip of the clips being pushed by an operation member; and,

FIG. 5 is a schematic sectional view of the clip driver in the present invention, showing the clips being urged by a follow member to advance.

### DETAILED DESCRIPTION OF THE PREFERRED EMBODIMENT

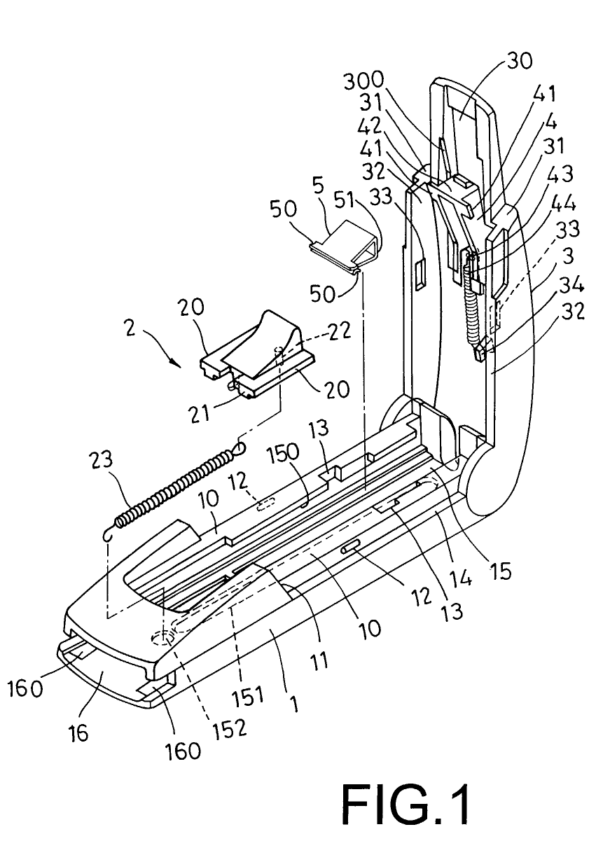

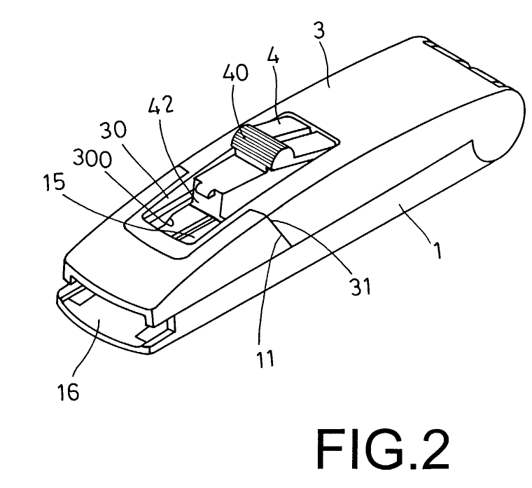

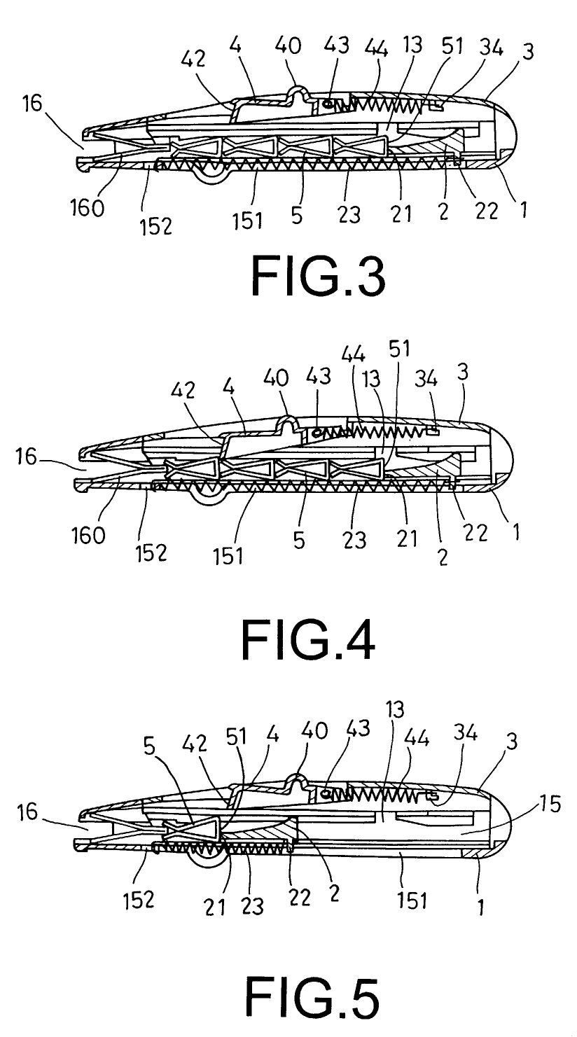

A preferred embodiment of a clip driver in the present invention, as shown in FIGS. 1 to 3, mainly includes base 1, a follow member 2, an upper cap 3 and an operation member 4.

The base 1 has two supporting edges 10 respectively disposed at both sides thereof, two slopes 11 respectively formed in proper positions of front portions of the two supporting edges 10, at least one engagement block 12 disposed on an outer surface of each of two sidewalls of middle portions of the two supporting edges 10, a feed inlet 13 disposed at a proper position between two rear portions of the two supporting edges 10, two step parts 14 respectively extending downwards from rear portions of the two slopes 11, a channel 15 disposed therein, and a clipping opening 16 formed in a front end thereof. The channel 15 has two slide grooves 150 respectively disposed at both sidewalls thereof and an elongated slot 151 disposed at a bottom thereof. An engagement hole 152 is formed in front of the elongated slot 151. Two elastic plates 160 are respectively mounted at both sides of the clipping opening 16 just corresponding to the two slide grooves 150 for stretching clips 5 widely.

A follow member 2 combined in the channel 15 of the base 1 has two side parts 20 just respectively accommodated in the two slide grooves 150 of the channel 15, a stop part 21 disposed in a front end thereof for urging the clips 5 to advance close to each other, and a projection 22 downwardly protruded from a bottom surface thereof and capable of extending into the elongated slot 151 of the channel 15 to be hooked by one end of a first spring 23 whose the other end hooking the engagement hole 152 in front of the elongated slot 151 of the channel 15.

An upper cap 3 pivoted on the base 1 has an elongated through groove 30 formed in a front portion thereon, two slopes 31 respectively extending downwards from proximate middle portions thereof for corresponding in location to the two slopes 11 of the base 1, two sidewalls 32 respectively disposed behind the two slopes 31 for corresponding in location to the two step parts 14 of the base 1, at least one engagement groove 33 disposed in an inner surface of each of the two sidewalls 32 thereof for corresponding in location to the engagement block 12 of the base 1, and a hook block 34 disposed in a proper position of an inner surface behind the elongated through groove 30. The elongated through groove 30 has two guide rails 300 respectively disposed at both sides of an inner surface of a bottom thereof. The two slopes 31 and the two sidewalls 32 are designed to be matched with the two slopes 11 and the two step parts 14 of the base 1 so that when the upper cap 3 is closed on the base 1, the upper cap 3 and the base 1 can be perfectly combined together as a whole body.

An operation member 4 combined in the elongated through groove 30 of the upper cap 3 has a protrusion 40 disposed at an upper portion thereof for the convenience of pushing the operation member 4 forwards, two wing parts 41 respectively disposed at both sides thereof for corresponding in location to the two guide rails 300 of the elongated through groove 30 of the upper cap 3, a push end 42 extending from a front end thereof, and a hook block 43 disposed at a proper position thereof and capable of being connected with the hook block 34 of the upper cap 3 by a second spring 44.

In filling the clips 5, as shown in FIGS. 1 to 5, firstly open the upper cap 3, and then pull the follow member 2 backwards to the rear end of the channel 15 of the base 1. Secondly, fill the clips 5 into the channel 15 of the base 1 from the feed inlet 13 one by one to be set in a row with two lugs 50 at both sides of each of clips 5 to be just respectively accommodated in the two slide grooves 150 of the channel 15. Thirdly, release the follow member 2 to urge the clips 5 to advance close to each other. When the follow member 2 is released, it will be pulled forwards by the first spring 23 to make the lugs 50 of the clips 5 slide forwards along the two slide grooves 150 of the channel 15 and to make the stop part 21 urging against a back portion 51 of a rearmost clip 5 so that the clips can be pushed forwards to be close to each other and arranged in a row. Finally, close the upper cap 3 with the engagement blocks 12 of the base 1 engaged with the engagement grooves 33 of the upper cap 3 in position, by which the work of filling the clips 5 into the channel 15 of the base 1 is completed.

In clipping sheets of paper or documents, only push the protrusion 40 of the operation member 4 forwards with fingers to make the push end 42 of the operation member 4 urging a back portion 51 of a foremost clip 5. When the foremost clip 5 is to be pushed out of the clipping opening 16 of the base 1, the two elastic plates 160 respectively mounted at both sides of the clipping opening 16 will stretch the foremost clip 5 widely so as to make the foremost clip 5 clipping the sheets of paper or documents quickly and steadily. Moreover, since the projection 22 of the follow member 2 is hooked by the first spring 23 that is accommodated in the elongated slot 151 of the channel 15 and has the other end hooking in the engagement hole 152, the follow member 2 can urge the clips 5 advance close to each other under the pulling force of the first spring 23, by which the clip driver of the present invention can push clips 5 out of the clipping opening 16 to clip the sheets of paper or documents one by one in continuous operations.

The invention has the following advantages, as can be understood from the aforesaid description.

1. The clip driver of the present invention is convenient in filling the clips.

2. The clip driver of the present invention can make the clips promptly clipping sheets of paper or documents one by one in continuous operations

3. The clip driver of the present invention can displace the clips quickly and steadily to make the operation of the clips more accurate.

While the preferred embodiment of the invention has been described above, it will be recognized and understood that various modifications may be made therein and the appended claims are intended to cover all such modifications that may fall within the spirit and scope of the invention.

What is claimed is:

1. A clip driver comprising:
a base having two supporting edges respectively disposed at both sides thereof, at least one engagement block disposed on an outer surface of each of two sidewalls thereof, a feed inlet disposed at a proper position thereof, a channel disposed therein, and a clipping opening formed in a front end thereof, said channel having two slide grooves respectively disposed at both sides thereof and an elongated slot disposed at a bottom thereof;
a follow member being combined in said channel of said base for urging clips to advance close to each other, and having a projection downwardly protruded from a bottom surface thereof and capable of extending into said elongated slot of said channel to be hooked by one end of a first spring whose the other end hooking in front of said elongated slot of said channel;
an upper cap being pivoted on said base, and having an elongated through groove formed thereon, at least one engagement groove disposed in an inner surface of each of two sidewalls thereof for corresponding in location to said engagement blocks of said base, and a hook block disposed in a proper position of an inner surface thereof;
an operation member being combined in said elongated through groove of said upper cap, and having a push end extending from a front end thereof and a hook block disposed at a bottom thereof and capable of being connected with said hook block of said upper cap by a second spring; and,
whereby in filling said clips, after said upper cap is open, said follow member is pulled backwards to make said clips filled into said channel of said base from said feed inlet one by one, further said follow member is released to urge said clips to advance close to each other, and then said upper cap is closed; in clipping sheets of paper or documents, only push said operation member forwards with fingers to push a foremost clip out to clip said sheets of paper or documents, by which said clips can be displaced quickly and steadily to clip said sheets of paper or documents one by one in continuous operations.

2. The clip driver as claimed in claim 1, wherein an engagement hole is formed in front of said elongated slot of said channel of said base for said first spring of said follow member to hook in position.
